(19) United States
(12) Patent Application Publication
(10) Pub. No.: US 2026/0251876 A1
(43) Pub. Date: Aug. 27, 2026

(54) CABLE ENCLOSURE STRUCTURALLY CONFIGURED TO CONNECT DIFFERENT FIBER OPTIC CONNECTOR TYPES WITH AN ADAPTER WHILE MINIMIZING CABLE BENDS SO AS TO MITIGATE SIGNAL LOSS

(71) Applicant: PPC BROADBAND, INC., East Syracuse, NY (US)

(72) Inventors: Kim LEESON, Ipswich (GB); Shaun TREZISE, Aldeburgh (GB); Billyjoe CHURCHYARD, Ipswich (GB)

(73) Assignee: PPC BROADBAND, INC., East Syracuse, NY (US)

(21) Appl. No.: 19/005,682

(22) Filed: Dec. 30, 2024

Related U.S. Application Data
(60) Provisional application No. 63/616,614, filed on Dec. 30, 2023.

(51) Int. Cl. G02B 6/44; G02B 6/38

(52) U.S. Cl. CPC G02B 6/44465; G02B 6/3825; G02B 6/3881; G02B 6/38875; G02B 6/445

(57) ABSTRACT

A cable enclosure may include a housing portion and a holding portion disposed in the interior cavity of the housing and structurally configured to alternatively hold an SC fiber optic adapter and an LC duplex fiber optic adapter. The housing portion may include a first side wall portion structurally configured to include a first cable receiving port that is structurally configured to receive a first cable in a sealed configuration, and a second side wall portion structurally configured to include a second cable receiving port structurally configured to receive a second cable in a sealed configuration. The first cable receiving port may be structurally configured to be aligned with a center of the holding portion, and the second cable receiving port may be structurally configured to be offset from the first cable receiving port and from a center of the holding portion. The first cable receiving port may be structurally configured to sealingly receive and align a cable terminated with an SC connector with a port of an SC adapter held by the holding portion, and the second cable receiving port may be structurally configured to sealingly receive and align a cable terminated with an LC connector with a port of an LC adapter held by the holding portion such that the enclosure is structurally configured to permit alternative use with an SC terminated cable and SC adapter and an LC terminated cable and LC adapter while minimizing bending of the SC terminated cable and the LC terminated cable so as to mitigate signal loss.

### CROSS-REFERENCE TO RELATED APPLICATION

This application claims the benefit of U.S. Provisional Patent Application No. 63/616,614, filed on Dec. 30, 2023, the disclosure of which is hereby incorporated by reference herein in its entirety.

### TECHNICAL FIELD

The present disclosure is directed to a fiber optic enclosure and, more particularly, to a sealed fiber optic cable enclosure arranged to provide alternative connections of differently configured cables so as to mitigate signal loss.

### BACKGROUND

In an effort to satisfy the ever-increasing demand for data and signal bandwidth, distributed networks of cables have been constructed. Advancements in technology, along with routine maintenance, often result in changes, alterations, adaptations of existing distributed network infrastructure. Such modifications can produce redundant, unutilized, and/or excessive network components that pose reliability risks as well as degraded performance capabilities.

While a variety of different signal carrying cables may be employed to accommodate different installation sites, the physical placement of cables may pose difficulties and challenges. For instance, cables with different diameters, bend capabilities, and environmental protections may be selected based on the type of consumer, physical layout of an installation site, and/or signal transmission needs of the consumer. The ability to implement signal carrying cables into a distributed network may include the addition of network components that pose reliability and performance risks.

Accordingly, it may be desirable to provide a fiber optic cable enclosure that is structurally configured to provide alternative connections for differently configured cables and alternative adapters while preventing bending of cables so as to mitigate signal loss.

### SUMMARY

In accordance with various aspects of the disclosure, a fiber optic cable enclosure may include a housing portion, a lid portion structurally configured to be coupled with the housing portion, and a holding portion disposed in the interior cavity and structurally configured to alternatively hold an SC fiber optic adapter and an LC duplex fiber optic adapter. The housing portion and the lid portion may be configured to define a first side wall portion and a second opposite side wall portion, the housing portion may have a first seal portion continuously extending about a perimeter of the housing portion, the lid portion may have a second seal portion continuously extending about a perimeter of the lid portion, and the first seal portion and the second seal portion may have matching structural configurations. The housing portion and the lid portion may be structurally configured to receive a fiber distribution cable in a pass through configuration, the first side wall portion may be structurally configured to include a first cable receiving port that is structurally configured to receive a cable having a first diameter in a sealed configuration, and the second side wall portion may be structurally configured to include a second cable receiving port structurally configured to receive a cable having a second diameter, smaller than the first diameter, in a sealed configuration. The first cable receiving port may be structurally configured to be aligned with a center of the holding portion, and the second cable receiving port may be structurally configured to be offset from the first cable receiving port and from a center of the holding portion. The first cable receiving port is structurally configured to sealingly receive and align a cable having the first diameter and terminated with an SC connector with a port of an SC adapter held by the holding portion, and the second cable receiving port is structurally configured to sealingly receive and align a cable having the second diameter and terminated with an LC connector with a port of an LC adapter held by the holding portion such that the enclosure is structurally configured to permit alternative use with an SC terminated cable and SC adapter and an LC terminated cable and LC adapter while minimizing bending of the SC terminated cable and the LC terminated cable so as to mitigate signal loss.

In some embodiments of the aforementioned cable enclosure, the lid portion may be configured to be hingedly coupled with the housing portion.

In some embodiments of the aforementioned cable enclosures, the first cable receiving port may be structurally configured to align a cable with a port on a first side of an adapter held by the holding portion that faces the first side wall portion.

In some embodiments of the aforementioned cable enclosures, the second cable receiving port may be structurally configured to align a cable with a port on a second side of an adapter held by the holding portion that faces the second side wall portion.

In accordance with various aspects of the disclosure, a fiber optic cable enclosure may include a housing portion structurally configured to define an interior cavity, and a holding portion disposed in the interior cavity and structurally configured to alternatively hold an SC fiber optic adapter and an LC duplex fiber optic adapter. The housing portion may include a first side wall portion and a second opposite side wall portion, the housing portion may be structurally configured to receive a fiber distribution cable in a pass through configuration, the first side wall portion may be structurally configured to include a first cable receiving port that is structurally configured to receive a cable having a first diameter in a sealed configuration, and the second side wall portion may be structurally configured to include a second cable receiving port structurally configured to receive a cable having a second diameter, smaller than the first diameter, in a sealed configuration. The first cable receiving port may be structurally configured to be aligned with a center of the holding portion, and the second cable receiving port may be structurally configured to be offset from the first cable receiving port and from a center of the holding portion. The first cable receiving port may be structurally configured to sealingly receive and align a cable having the first diameter and terminated with an SC connector with a port of an SC adapter held by the holding portion, and the second cable receiving port may be structurally configured to sealingly receive and align a cable having the second diameter and terminated with an LC connector with a port of an LC adapter held by the holding portion such that the enclosure is structurally configured to permit alternative use with an SC terminated cable and SC adapter and an LC terminated cable and LC adapter while minimizing bending of the SC terminated cable and the LC terminated cable so as to mitigate signal loss.

In some embodiments of the aforementioned cable enclosures, the housing portion may include a base portion and a lid portion coupled with the base portion.

In some embodiments of the aforementioned cable enclosures, the base portion and the lid portion may be structurally configured to cooperate to define the first cable receiving port and the second cable receiving port.

In some embodiments of the aforementioned cable enclosures, the base portion may have a first seal portion continuously extending about a perimeter of the base portion, and wherein the lid portion may have a second seal portion continuously extending about a perimeter of the lid portion such that the first seal portion and the second seal portion are structurally configured to cooperate to seal the housing portion.

In some embodiments of the aforementioned cable enclosures, the lid portion may be configured to be hingedly coupled with the housing portion.

In some embodiments of the aforementioned cable enclosures, the first cable receiving port may be structurally configured to align a cable with a port on a first side of an adapter held by the holding portion that faces the first side wall portion.

In some embodiments of the aforementioned cable enclosures, the second cable receiving port may be structurally configured to align a cable with a port on a second side of an adapter held by the holding portion that faces the second side wall portion.

In accordance with various aspects of the disclosure, a fiber optic cable enclosure may include a housing portion structurally configured to define an interior cavity and a holding portion disposed in the interior cavity and structurally configured to alternatively hold an SC fiber optic adapter and an LC duplex fiber optic adapter. The housing portion may include a first side wall portion structurally configured to include a first cable receiving port that is structurally configured to receive a first cable in a sealed configuration, and a second side wall portion structurally configured to include a second cable receiving port structurally configured to receive a second cable in a sealed configuration. The first cable receiving port may be structurally configured to be aligned with a center of the holding portion, and the second cable receiving port may be structurally configured to be offset from the first cable receiving port and from a center of the holding portion. The first cable receiving port may be structurally configured to sealingly receive and align a cable terminated with an SC connector with a port of an SC adapter held by the holding portion, and the second cable receiving port may be structurally configured to sealingly receive and align a cable terminated with an LC connector with a port of an LC adapter held by the holding portion such that the enclosure is structurally configured to permit alternative use with an SC terminated cable and SC adapter and an LC terminated cable and LC adapter while minimizing bending of the SC terminated cable and the LC terminated cable so as to mitigate signal loss.

In some embodiments of the aforementioned cable enclosures, the housing portion may include a base portion and a lid portion coupled with the base portion.

In some embodiments of the aforementioned cable enclosures, the base portion and the lid portion may be structurally configured to cooperate to define the first cable receiving port and the second cable receiving port.

In some embodiments of the aforementioned cable enclosures, the base portion may have a first seal portion continuously extending about a perimeter of the base portion, and wherein the lid portion may have a second seal portion continuously extending about a perimeter of the lid portion such that the first seal portion and the second seal portion are structurally configured to cooperate to seal the housing portion.

In some embodiments of the aforementioned cable enclosures, the lid portion may be configured to be hingedly coupled with the housing portion.

In some embodiments of the aforementioned cable enclosures, the first cable receiving port may be structurally configured to align a cable with a port on a first side of an adapter held by the holding portion that faces the first side wall portion.

In some embodiments of the aforementioned cable enclosures, the second cable receiving port may be structurally configured to align a cable with a port on a second side of an adapter held by the holding portion that faces the second side wall portion.

In some embodiments of the aforementioned cable enclosures, the first cable receiving port may be structurally configured to receive a cable having a first diameter in a sealed configuration, and the second side wall portion is structurally configured to receive a cable having a second diameter, smaller than the first diameter, in a sealed configuration.

In some embodiments of the aforementioned cable enclosures, the first cable receiving port may be structurally configured to sealingly receive and align a cable having the first diameter and terminated with an SC connector with a port of an SC adapter held by the holding portion, and the second cable receiving port may be structurally configured to sealingly receive and align a cable having the second diameter and terminated with an LC connector with a port of an LC adapter held by the holding portion.

### BRIEF DESCRIPTION OF THE DRAWINGS

Further advantages and features of the present disclosure will become apparent from the following description and the accompanying drawings, to which reference is made.

FIG. 1 is a line representation of portions of a distributed network environment in which assorted embodiments of this disclosure may be practiced.

FIG. 2 is a line representation of portions of a cable assembly that may be employed in the environment of FIG. 1.

FIG. 3 is a line representation of portions of an interconnect structurally configured to be employed in the distributed network environment of FIG. 1.

FIG. 4 is a line representation of portions of an interconnect arranged in accordance with various embodiments of this disclosure.

FIG. 5 is a schematic view of an exemplary fiber optic enclosure in accordance with various embodiments of this disclosure.

FIG. 6 is a perspective view of the fiber optic enclosure of FIG. 5.

FIG. 7 is a perspective view of the fiber optic enclosure of FIG. 5.

FIG. 8 is an end view of the fiber optic enclosure of FIG. 5.

FIG. 9 illustrates plan views of the fiber optic enclosure of FIG. 5.

FIG. 10 is a top view of the fiber optic enclosure of FIG. 5.

### DETAILED DESCRIPTION

Embodiments provide an interconnect for a distributed network that is structurally configured to provide outdoor protection and efficient electrical connection of cables with dissimilar configurations.

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

In practice, a single, continuous cable is not utilized for each end user. Instead, a number of interconnects provide continuous signal pathways through numerous separate cable, which consolidates the physical footprint of a distributed network. With increased utilization of differently configured cables for assorted environments, applications, and capabilities, many interconnects may be employed to adapt different cables to allow signal transmission. Hence, various embodiments are generally directed to an interconnect for a distributed network that efficiently adapts differently configured cables while providing robust outdoor environment protection.

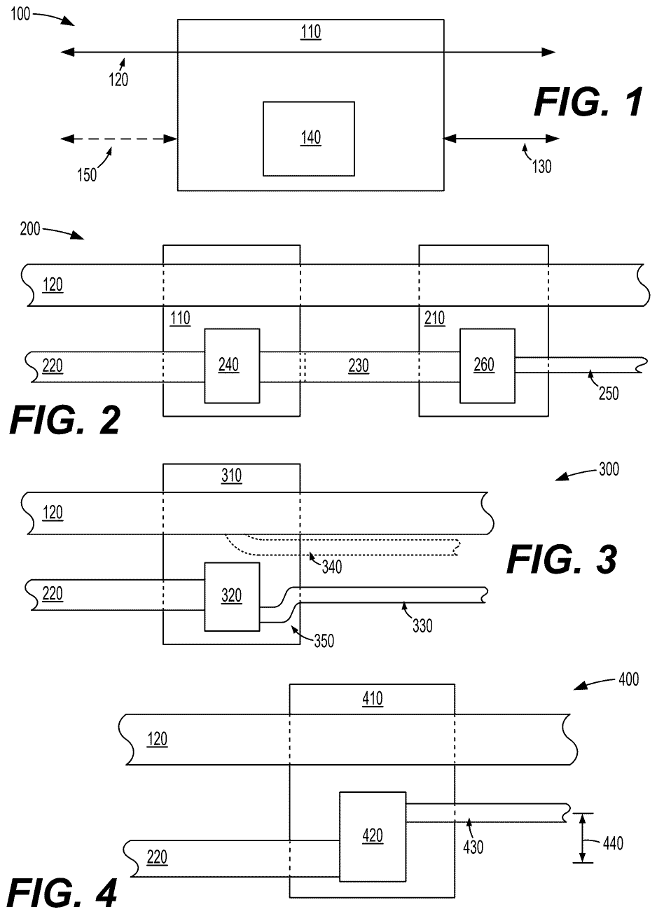

Turning to the drawings, FIG. 1 is a line representation of a portion of a distributed network environment 100 in which embodiments of an interconnect 110 can be practiced. Any number, and type, of interconnect 110 may provide at least one stable signal pathway between a source and destination. While a single cable 120 may continuously extend between a source and destination alone, or through the interconnect 110, the interconnect 110 may connect the cable 120 with another, separate cable 130 to form single continuous signal pathway. A cable adapter 140 may facilitate the connection of multiple separate cables 120/130/150 to allow one-way, or two-way, signal transmission between source(s) and destination(s).

It is noted that a cable 120/130/150 can provide at least one stable signal pathway with one or more signal transmission portions, such as an electrically conducting wire or optical conduit. The network environment 100 may include a single source 120 connected to a single destination 130 via a single, continuously extending cable 120. However, such configuration is not required as one or more interconnects 110, such as a switch, server, connector, splitter, or other device, may provide one or more stable signal pathways with numerous separate cables 120/130/150, as generally shown in FIG. 1. The ability to use one or more adapters 140 allows an interconnect 110 to form and maintain signal pathways that constitute a distributed signal network.

The ability to connect separate cables 120/130/150 to form signal pathways with the interconnect 110 may provide efficient use of wires with relatively low physical footprint and complexity. Yet, an interconnect 110 may have size, space, connectivity, and/or compatibility difficulties that degrade some efficiencies. FIG. 2 illustrates a line representation of portions of a cable assembly 200 that may operate as part of the distributed network environment 100 of FIG. 1 in some embodiments. It is contemplated that come interconnects 110 may be limited in the cable configurations that may be employed.

For instance, an interconnect 110 may have cable size and/or connectivity restrictions that correspond with being able to physically support cables 120 with certain diameters or electrically connect cables 120 with matching end connectors, such as a Subscriber connector (SC connector), or a Lucent connector (LC connector) in simplex, duplex, or quad arrangements. Such physical and/or connection restrictions may require one or more secondary interconnects 210 to allow dissimilar cables to be employed to provide a signal pathway. The non-limiting cable assembly 200 of FIG. 2 conveys how a first interconnect 110 translates a first cable 220 into a second cable 230 that has a matching diameter with a first adapter 240 before the second cable 230 is translated into a third cable 250 via a second adapter 260 positioned within the physically separate interconnect 210.

The output cable 230 from the first interconnect 110 may have a similar or dissimilar connection configuration from the input cable 220 while maintaining a matching cable diameter. In order to output a cable 250 with a different diameter, the second interconnect 210 is employed. That is, the first interconnect 110 is not capable of translating different cable diameters into a single signal pathway and the second interconnect 210 provides such capability. The use of an additional adapter 260 can further allow for translation of cable connection configurations, but such translation is not required as matching cable connection configurations may be present for the input and output of each adapter 240/260.

While the use of additional interconnects 210 may provide increased connectivity compared to some individual interconnects 110. However, the use of additional interconnects 210 can introduce greater physical footprints and increased points of potential failure compared to an interconnect 110 that allows cable connectivity and diameter to be altered in a single housing. FIG. 3 illustrates a line representation of a cable assembly 300 that employs an interconnect 310 structurally configured to alter both cable connectivity and diameter in accordance with some embodiments. The interconnect 310 is shown with a single pass-through cable 120 and an adapter 320 structurally configured to connect an input cable 220 with an output cable 330.

The interconnect 310, in some embodiments, is structurally configured to house and protect portions of the pass-through cable 120 as well as the adapter 320 and electrical connection between the respective separate cables 220/330. Such protection may be in the form of a watertight, water resistant, or otherwise sealed enclosure that defines a cavity where the adapter 320 is positioned to allow accurate and consistent electrical connections between the cables 220/330. It is contemplated, but not required, that the housing of the interconnect 310 is further utilized to connect one or more cables to the pass-through cable 120, which can be characterized as a splice connection resulting in segmented output cable 340.

Although the adapter 320 may provide electrically efficient translation of the input cable 220 into the output cable 330, the physical translation through the adapter 320 may present challenges to installation and/or operation reliability over time. As shown, the adapter 320 may be structurally configured to electrically connect two separate cables 220/330, but may do so with an off-center exit that results in a cable stress 350, such as a twist, bend, or kink in the output cable 330. For instance, the input cable 220 may have a different connector than the output cable 330 and, consequently, the adapter 320 has an exit that is spaced a distance from the adapter's center, which is aligned with the centerline of the input cable 220 in FIG. 3.

The presence of the cable stress 350 may correspond to inadvertent physical stress on the connector of the output cable at the adapter 320 and/or along the cable 330 as it exits the interconnect 310 housing. Accordingly, various embodiments are directed to an interconnect 310 that structurally provides an ability to change cable diameter and/or connector configurations in a single housing without posing heightened risk of cable stress 350 similar to those illustrated in FIG. 3.

FIG. 4 illustrates a line representation of a cable assembly 400 that employs an interconnect 410 structurally configured to increase the efficiency of a distributed network environment, such as environment 100 of FIG. 1. The non-limiting embodiment of the interconnect 410 houses an adapter 420 that can translate different connector configurations, such as LC connector to SC connector, from an input cable 220 that has a first diameter to an output cable 430 that has a smaller diameter.

The interconnect 410 is structurally configured to position the output cable 430 a predetermined offset distance 440 from the input cable 220. Such offset distance 440 may be measured from cable centerline, parallel to the longitudinal axis of each cable 220/430. The result of positioning the output cable 430 in a dissimilar location on the adapter 420 relative to the input cable 220 allows the output cable 430 allows the adapter 420 to accommodate different connector configurations without applying cable stress on the output cable 430. In other words, the offset distance 440 corresponds with a substantially straight output cable 430 from the adapter 420 through an external wall of the interconnect 410, which differs from the cable stress 340 and output cable 330 arrangement of cable assembly 300.

It is noted that the output cable 430 continuously extends through an aperture in the interconnect 410 and, in some embodiments, the aperture is structurally configured to withstand outdoor operation. That is, the interconnect 410 can be watertight, water resistant, or otherwise sealed while supporting the output cable 430 in a substantially straight arrangement. In contrast to the interconnect 310 of FIG. 3 that may have multiple different apertures in which the output cable 330 may be positioned, the predetermined offset distance 440 of the interconnect 410 of cable assembly 400 provides a more robust sealing structure as multiple interconnect housing apertures do not need to be sealed. In other words, the offset distance 440 corresponding with the output cable 430 position relative to the adapter 420 allows for fewer interconnect housing apertures and a more efficient sealing of the interconnect 410 compared to interconnect housings that provide multiple possible output cable 330 exit apertures.

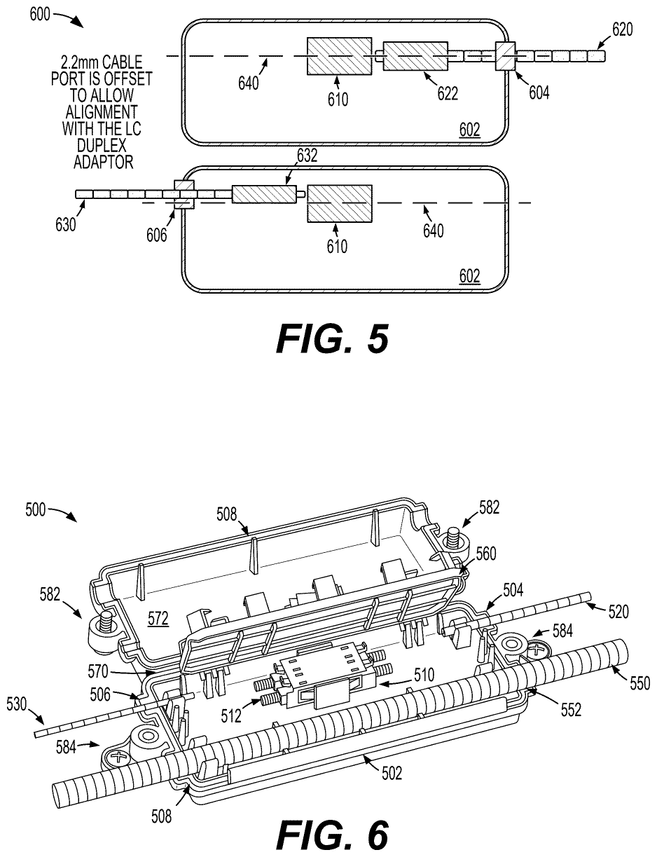

Turning to FIGS. 5-10, a cable assembly 500 is illustrated in a variety of embodiments that provide different cable interconnections. It is noted that the non-limiting cable assembly 500 shown in FIG. 5 is a modification of FIGS. 6-10. In accordance with various embodiments, the cable assembly 500 of FIGS. 6-10 is structurally configured to provide two different sized openings, which may be sized to fit 3 mm and 2.2 mm cables, respectively.

It is contemplated that the duct includes a multifiber cable that goes to a building. At the building, one of interconnect housings 502 may be installed by pulling out one fiber from the multifiber cable duct and splicing to a pigtail (short cable with a one bare end for splicing and one preterminated end for plugging into an adapter). Subsequently, a preterminated drop cable, such as a 2.2 mm or 3 mm cable, may be plugged into the opposite port of the adapter where the pigtail is plugged. The unused cable port, such as a port adapted for either 2.2 mm or 3 mm cables, may be plugged/sealed. The structural configuration of an interconnect housing 502 allows reduction in inventory because the same housing 502 can be used with two different sized cables. However, the cable ports may be mis-aligned in the event different connector types, such as SC and LC, are concurrently employed.

Hence, various embodiments are directed to the housing 502 shown in FIGS. 6-10, which may hold different types of adapters, such as either an SC simplex (one port on either side) or an LC duplex (2 ports on either side). It is noted that an SC simplex adapter and an LC duplex adapter have a matching physical footprint. Since the ports of the SC and LC adapters may be misaligned if the housing ports are aligned along the adapter centerline, the offset port configuration shown in FIG. 5 correct such misalignment. For instance, a 3 mm cable may be used with an SC connector and SC adapter, and the 2.2 mm cable may be used with an LC connector and LC adapter. As a result, the service provide may stock a single enclosure that can be used with either SC or LC duplex adapters. Thus, adapter/connectors may be intelligently chosen with appropriate cable size or a cable size may be chosen with an appropriate adapter/connector.

FIGS. 6-10 respectively illustrate assorted views of an exemplary cable enclosure 500 structurally configured in accordance with various embodiments to provide a robust outdoor enclosure that provides optimal translation of cable diameter and connection configurations without imposing cable stress. FIG. 5 is a line representation of portions of a housing portion 502 in which an adapter 510, such as a fiber optic adapter, is held by a holding portion and is positioned to receive an output cable 520, 530, or drop cable, such as a 3 mm or 2.2 mm grooved cable, for example, a Miniflex grooved cable. As illustrated, the adapter comprises an LC duplex adapter and thus, the drop cable 520/530 would be terminated with an LC connector 532, as would be understood by persons skilled in the art. The cable enclosure 500 may be configured to have an ingress protection rating of IP67 so as to protect the contents of the enclosure 500 from its surrounding elements.

The enclosure 500 includes a first cable receiving port 504 and a second cable receiving port 506 at opposite side wall portions of the housing portion 502. The first port 504 may be sized and configured to receive a 3 mm drop cable 520 in a sealed relationship, and the second port 506 may be sized and arranged to receive a 2.2 mm drop cable 530 in a sealed relationship. The enclosure 500 is thus configured to provide a sealed connection with a 3 mm cable or a 2.2 mm cable, while maintaining an IP67 rating for outdoor use, thereby allowing a service provider to stock a single inventory item for use with two different sizes of drop cable. In some aspects, the enclosure 500 will be used to connect a single fiber from a multifiber distribution cable to a single drop cable-either cable 520 or cable 530. In such an aspect, an unused one of the first and second ports 504, 506 can be sealed with a plug or other sealing portion to maintain the IP67 rating for outdoor use. Conventional enclosures typically provide a single size port for such different sized cables, thereby requiring a service provide to stock different inventory items for different sized cables and/or jeopardizing the weatherproof rating of such an enclosure if not properly sealed due to use with a mis-sized cable.

FIG. 6 conveys a perspective view of the exemplary enclosure 500 with a duct 550 containing a multi-fiber distribution cable. The duct 550 has a larger diameter than either the drop cable 520/530, and the enclosure includes ports 552 at the same, opposite side wall of the housing 502 that include the first and second portions 504/506, such that the duct 550 is arranged in a pass-through configuration. The interconnect housing portion 502 has contains a tray portion 560 that may be structurally configured to retain assorted connection equipment, such as patch cable sleeves, clamps, and repair tools. The housing portion 502 may further have a hinge portion 570 that attaches and aligns a lid portion 572 so that seals 508 nested in the respective housing portion 502 and lid portion 572 contact to form a substantially watertight barrier when the lid portion 572 is closed atop the housing 502. The hinge portion 570 may additionally align a fastening portion 582 of the lid portion 572 with a mounting portion 584 of the housing portion 502.

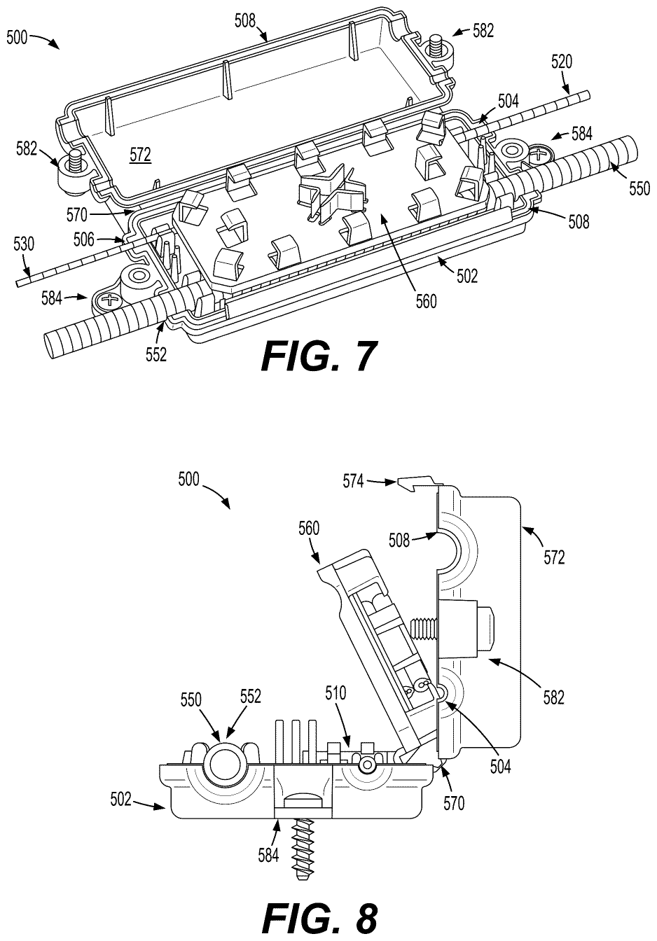

The tray portion 560, in some embodiments, is affixed within the housing portion 502 in a manner that allows rotation. FIG. 6 illustrates how the tray portion 560 can remain attached to the housing 502 while rotating to expose the adapter 510 and connections of the respective cables 520/530. FIG. 7 shows how the tray portion 560 can rotate to rest atop the adapter 510 and duct 550, which may allow efficient access to the assorted equipment secured by the various features of the tray portion 560.

The perspective view of FIG. 7 also shows how the seals 508 of the housing portion 502 and lid portion 572 continuously extend around the perimeter of each component while having greater thickness in apertures 504/506/552 in which cables 520/530/550 occupy. That is, the respective seals 508 have a relatively uniform thickness, and continuous structure, except in apertures 506/508/552 where cables 520/530/550 enter or exit the housing/lid portion. It is noted that the seals 508 of the respective housing 502 and lid portion 572 have matching sizes, shapes, and materials, but such structural configuration is not required as the seal 508 of the lid portion 572 may differ from the seal 508 of the housing 502 while still providing a substantially watertight apparatus when closed.

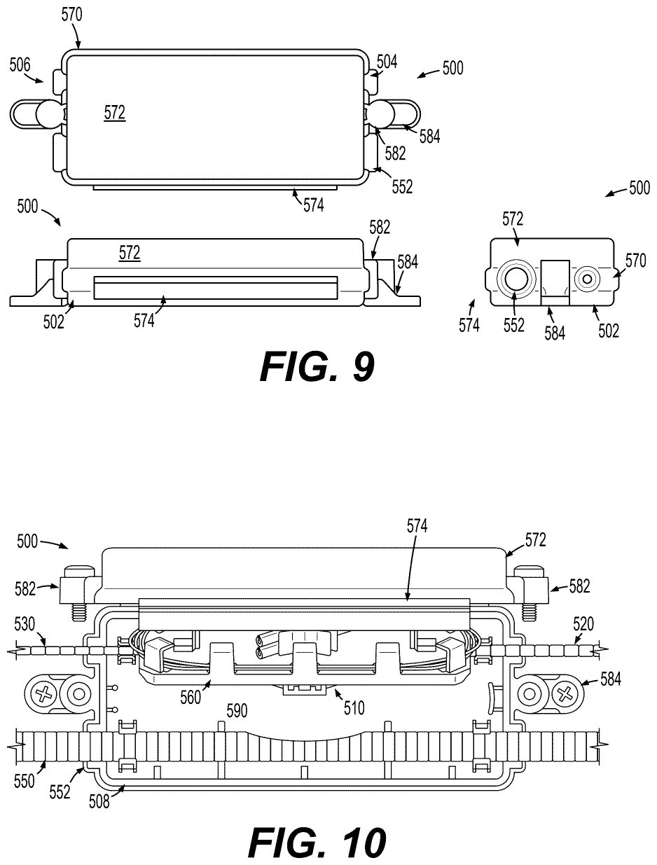

In FIG. 8, a side perspective view of the cable assembly 500 conveys how the hinge portion 570 provides physical attachment of the lid portion 572 and the housing 502. The rotating capability of the tray portion 560 is also illustrated in FIG. 8. The lid portion 572 has a single latch portion 574 that may provide closure support when engaging aspects of the housing 502, as generally shown in FIG. 9. Some embodiments of the cable assembly 500 utilize the latch portion 574 alone to promote and support the sealing of the lid portion 572 and housing 502. Meanwhile, other embodiments employ the latch portion 574 in combination with the fastening portion 582, which includes a fastener that engages a threaded aperture of the mounting portion 584, as shown in FIG. 9.

It is contemplated that any type and size of fastener may be utilized to physically secure the lid portion 572 to the housing 502. For instance, a keyed protrusion, magnets, screws, rivets, or any combination thereof may be structurally configured to allow external access and engagement that ensures a watertight fit of the lid portion 572 to the housing 574. That is, the external location of the fastening portion 582 allows a technician to apply additional closing force onto the seals 508 and interacting surfaces of the lid portion 572 and housing 502 to complement the physical closing support provided by the latch portion 574 and promote an optimized seal 508 around the perimeter of the housing/lid portion along with around each cable 520/530/550.

FIG. 9 displays top, front, and side plan views of the cable assembly 500 when the lid portion 572 is closed and secured on the housing 502. It is noted that the cables of FIGS. 5-8 have been removed in FIG. 9, but such arrangement is not required and is omitted merely for clarity. That is, the cable assembly 500 is expected to have each aperture 504/506/552 filled by a cable 520/530/550 in order to fully seal the interior cavity of the housing/lid portion in which one or more electrical connections are present via the adapter 510.

The closed orientation of the lid portion 572 relative to the housing 502, as conveyed in each view of FIG. 9, may protect the interior cavity from environmental conditions, such as wind, debris, rain, and other moisture. Some embodiments of the cable assembly 500 structurally configures the lid portion 572, housing 502, and seals 508 to provide a IP67 waterproof rating. Other embodiments of the cable assembly 500 structurally configure the lid portion 572, housing 502, latch portion 574, and hinge portion 570 as a single unitary component that is molded, printed, or otherwise constructed at the same time before being assembled with the seals 508, tray portion 560, adapter 510, and assorted cables 520/530/550.

FIG. 10 illustrates an embodiment of the cable assembly 500 where a section 590 of the duct 550 is removed to allow access to the signal carrying fibers contained therein. In some aspects, the enclosure 500 may include a cable, for example, a jacketed single fiber or jacketed multi-fiber cable, instead of the duct 550. To clarify, the removed section 590 of the duct 550, or cable, may be a removal a portion of, or portions of, one or more protective layers of the cable or an opening in a hollow duct that allows physical access to the one or more cables that extend within the duct.

Regardless of the structural configuration of the duct 550, or cable, the removed section 590 allows for additional connections, splices, or junctions to complement the connectivity provided by the adapter 510. For instance, the removed section 590 may allow one or more conductors contained in the duct 550, or cable, to be spliced into a new connection, for example, a preterminated pigtail fiber cable, which may be aided by the equipment secured in the tray portion 560. The enclosure 500 provides the ability to concurrently have multiple different types of electrical connections, such as spliced, connector, and tapped.

Referring now to FIG. 5, another exemplary enclosure 600 of a cable assembly 500 is structurally configured in accordance with various embodiments to provide a robust outdoor enclosure that provides optimal translation of cable diameter and connection configurations without imposing cable stress. As illustrated, the enclosure is configured for use with two different sized drop cables, wherein each of the different sized cables is terminated with a different type of connector. Other than the particular features of enclosure described below, the enclosure of FIG. 5 is similar to enclosures shown in FIG. 6-10.

The enclosure of FIG. 5 includes a holding portion (not shown) structurally configured to hold an adapter 610. The adapter 610 may be an SC adapter, for example, an SC simplex adapter, or an LC adapter, for example, and LC duplex adapter, since both are sized and configured to be held by the same holding portion. The drop cable 620 is a 3 mm cable, such as a Miniflex^{®}grooved cable, and the drop cable 630 is a 2.2 mm cable, such as a Miniflex® grooved cable.

The segmented line 640 corresponds with a center of the adapter 610. In a case of the adapter being an SC simplex adapter (upper drawing), the segmented line 640 also corresponds with a center of an SC connector 622, 3 mm drop cable 620, and sealed port 604 in the housing portion 602. In a case of the adapter being an LC duplex adapter (lower drawing), the segmented line 640 does not corresponds with a center of an LC connector 632, 2.2 mm drop cable 630, or sealed port 606 in the housing portion 602. Instead, segmented line 545 corresponds with a center of one LC port of an LC duplex adapter, an LC connector 632, 2.2 mm drop cable 630, and sealed port 606 in the housing portion 602.

As a result, the enclosure 600 illustrated in FIG. 5 can be used with either an SC simplex adapter or an LC duplex adapter, without requiring bending of the drop cable 620/630. For example, when SC connectors are desired, a service provider can equip the enclosure with an SC simplex adapter and provide a 3 mm drop cable 620 terminated with an SC connector for coupling with a port of the SC adapter without needing to bend the drop cable 620 to couple with the port. When LC connectors are desired, a service provider can equip the enclosure with an LC duplex adapter and provide a 2.2 mm drop cable 630 terminated with an LC connector for coupling with a port of the LC adapter without needing to bend the drop cable 630 to couple with the port. Of course, if the service provider prefers a particular sized drop cable, for example, either 3 mm or 2.2 mm, the corresponding connector type and adapter type can be used to accommodate the selected cable so as to avoid bending of the drop cable 620/630

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A fiber optic cable enclosure structurally configured to connect different fiber optic connector types with an adapter so as to mitigate signal loss, comprising
a housing portion;
a lid portion structurally configured to be coupled with the housing portion;
a holding portion disposed in the interior cavity and structurally configured to alternatively hold an SC fiber optic adapter and an LC duplex fiber optic adapter;
wherein the housing portion and the lid portion are configured to define a first side wall portion and a second opposite side wall portion;
wherein the housing portion has a first seal portion continuously extending about a perimeter of the housing portion;
wherein the lid portion has a second seal portion continuously extending about a perimeter of the lid portion;
wherein the first seal portion and the second seal portion have matching structural configurations;
wherein the housing portion and the lid portion are structurally configured to receive a fiber distribution cable in a pass through configuration;
wherein the first side wall portion is structurally configured to include a first cable receiving port that is structurally configured to receive a cable having a first diameter in a sealed configuration, and the second side wall portion is structurally configured to include a second cable receiving port structurally configured to receive a cable having a second diameter, smaller than the first diameter, in a sealed configuration;
wherein the first cable receiving port is structurally configured to be aligned with a center of the holding portion;
wherein the second cable receiving port is structurally configured to be offset from the first cable receiving port and from a center of the holding portion; and
wherein the first cable receiving port is structurally configured to sealingly receive and align a cable having the first diameter and terminated with an SC connector with a port of an SC adapter held by the holding portion, and the second cable receiving port is structurally configured to sealingly receive and align a cable having the second diameter and terminated with an LC connector with a port of an LC adapter held by the holding portion such that the enclosure is structurally configured to permit alternative use with an SC terminated cable and SC adapter and an LC terminated cable and LC adapter while minimizing bending of the SC terminated cable and the LC terminated cable so as to mitigate signal loss.

2. The cable enclosure of claim 1, wherein the lid portion is configured to be hingedly coupled with the housing portion.

3. The cable enclosure of claim 1, wherein the first cable receiving port is structurally configured to align a cable with a port on a first side of an adapter held by the holding portion that faces the first side wall portion.

4. The cable enclosure of claim 1, wherein the second cable receiving port is structurally configured to align a cable with a port on a second side of an adapter held by the holding portion that faces the second side wall portion.

5. A fiber optic cable enclosure structurally configured to connect different fiber optic connector types with an adapter so as to mitigate signal loss, comprising:
a housing portion structurally configured to define an interior cavity;
a holding portion disposed in the interior cavity and structurally configured to alternatively hold an SC fiber optic adapter and an LC duplex fiber optic adapter;
wherein the housing portion includes a first side wall portion and a second opposite side wall portion;
wherein the housing portion is structurally configured to receive a fiber distribution cable in a pass through configuration;
wherein the first side wall portion is structurally configured to include a first cable receiving port that is structurally configured to receive a cable having a first diameter in a sealed configuration, and the second side wall portion is structurally configured to include a second cable receiving port structurally configured to receive a cable having a second diameter, smaller than the first diameter, in a sealed configuration;
wherein the first cable receiving port is structurally configured to be aligned with a center of the holding portion;
wherein the second cable receiving port is structurally configured to be offset from the first cable receiving port and from a center of the holding portion; and
wherein the first cable receiving port is structurally configured to sealingly receive and align a cable having the first diameter and terminated with an SC connector with a port of an SC adapter held by the holding portion, and the second cable receiving port is structurally configured to sealingly receive and align a cable having the second diameter and terminated with an LC connector with a port of an LC adapter held by the holding portion such that the enclosure is structurally configured to permit alternative use with an SC terminated cable and SC adapter and an LC terminated cable and LC adapter while minimizing bending of the SC terminated cable and the LC terminated cable so as to mitigate signal loss.

6. The cable enclosure of claim 5, wherein the housing portion includes a base portion and a lid portion coupled with the base portion.

7. The cable enclosure of claim 6, wherein the base portion and the lid portion are structurally configured to cooperate to define the first cable receiving port and the second cable receiving port.

8. The cable enclosure of claim 6, wherein the base portion has a first seal portion continuously extending about a perimeter of the base portion, and wherein the lid portion has a second seal portion continuously extending about a perimeter of the lid portion such that the first seal portion and the second seal portion are structurally configured to cooperate to seal the housing portion.

9. The cable enclosure of claim 6, wherein the lid portion is configured to be hingedly coupled with the housing portion.

10. The cable enclosure of claim 5, wherein the first cable receiving port is structurally configured to align a cable with a port on a first side of an adapter held by the holding portion that faces the first side wall portion.

11. The cable enclosure of claim 5, wherein the second cable receiving port is structurally configured to align a cable with a port on a second side of an adapter held by the holding portion that faces the second side wall portion.

12. A fiber optic cable enclosure structurally configured to connect different fiber optic connector types with an adapter so as to mitigate signal loss, comprising:
a housing portion structurally configured to define an interior cavity;
a holding portion disposed in the interior cavity and structurally configured to alternatively hold an SC fiber optic adapter and an LC duplex fiber optic adapter;
wherein the housing portion includes a first side wall portion structurally configured to include a first cable receiving port that is structurally configured to receive a first cable in a sealed configuration, and a second side wall portion structurally configured to include a second cable receiving port structurally configured to receive a second cable in a sealed configuration;
wherein the first cable receiving port is structurally configured to be aligned with a center of the holding portion;
wherein the second cable receiving port is structurally configured to be offset from the first cable receiving port and from a center of the holding portion; and
wherein the first cable receiving port is structurally configured to sealingly receive and align a cable terminated with an SC connector with a port of an SC adapter held by the holding portion, and the second cable receiving port is structurally configured to sealingly receive and align a cable terminated with an LC connector with a port of an LC adapter held by the holding portion such that the enclosure is structurally configured to permit alternative use with an SC terminated cable and SC adapter and an LC terminated cable and LC adapter while minimizing bending of the SC terminated cable and the LC terminated cable so as to mitigate signal loss.

13. The cable enclosure of claim 12, wherein the housing portion includes a base portion and a lid portion coupled with the base portion.

14. The cable enclosure of claim 13, wherein the base portion and the lid portion are structurally configured to cooperate to define the first cable receiving port and the second cable receiving port.

15. The cable enclosure of claim 13, wherein the base portion has a first seal portion continuously extending about a perimeter of the base portion, and wherein the lid portion has a second seal portion continuously extending about a perimeter of the lid portion such that the first seal portion and the second seal portion are structurally configured to cooperate to seal the housing portion.

16. The cable enclosure of claim 13, wherein the lid portion is configured to be hingedly coupled with the housing portion.

17. The cable enclosure of claim 12, wherein the first cable receiving port is structurally configured to align a cable with a port on a first side of an adapter held by the holding portion that faces the first side wall portion.

18. The cable enclosure of claim 12, wherein the second cable receiving port is structurally configured to align a cable with a port on a second side of an adapter held by the holding portion that faces the second side wall portion.

19. The cable enclosure of claim 12, wherein the first cable receiving port is structurally configured to receive a cable having a first diameter in a sealed configuration, and the second side wall portion is structurally configured to receive a cable having a second diameter, smaller than the first diameter, in a sealed configuration.

20. The cable enclosure of claim 12, wherein the first cable receiving port is structurally configured to sealingly receive and align a cable having the first diameter and terminated with an SC connector with a port of an SC adapter held by the holding portion, and the second cable receiving port is structurally configured to sealingly receive and align a cable having the second diameter and terminated with an LC connector with a port of an LC adapter held by the holding portion.
